(19) United States
(12) Patent Application Publication
(10) Pub. No.: US 2009/0064047 A1
(43) Pub. Date: Mar. 5, 2009

(54) HYPERLINK SELECTION METHOD USING TOUCHSCREEN AND MOBILE TERMINAL OPERATING WITH HYPERLINK SELECTION METHOD

(75) Inventors: Jung Hyun SHIM, Seongnam-si (KR); Ju Hwan LEE, Incheon (KR); Nho Kyung HONG, Seoul (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/195,567

(22) Filed: Aug. 21, 2008

(30) Foreign Application Priority Data
Sep. 4, 2007 (KR) 10-2007-0089611

(51) Int. Cl. G06F 3/048

(52) U.S. Cl. 715/835

(57) ABSTRACT

A method of selecting one of a plurality of hyperlinks of a webpage viewed on a touchscreen of a mobile terminal is provided. A hyperlink selection method using a touchscreen includes detecting an occurrence of a touch event in which a touch point on the touchscreen displaying a webpage including a plurality of hyperlinks is touched, determining a number of hyperlinks involved in the touch event, displaying icons corresponding to the hyperlinks if the number of hyperlinks involved in the touch event is greater than or equal to two, and selecting an icon in response to movement of the touch point to one of the displayed icons.

### CROSS REFERENCE TO RELATED APPLICATION

This application claims priority from and the benefit of Korean Patent Application No. 10-2007-0089611, filed on Sep. 4, 2007, which is hereby incorporated by reference for all purposes as if fully set forth herein.

### BACKGROUND OF THE INVENTION

1. Field of the Invention

The present invention relates to a mobile terminal and, in particular, to a method of selecting one of a plurality of hyperlinks viewed on a touchscreen of a mobile terminal.

2. Discussion of the Background

A mobile terminal is a portable device, such as a Personal Mobile Communication Service Terminal, a Personal Digital Assistant (PDA), a Smartphone, or an International Mobile Telecommunication 2000 (IMT-2000) terminal, that supports wireless communication and various functions through application programs.

Mobile terminals are becoming slimmer and more compact, while being equipped with various multimedia functions such as MP3 playback, camera, navigation, and Internet access functions. Accordingly, the mobile terminal is becoming an essential element in everyday life.

Some recently emerging mobile terminals are equipped with a touchscreen, which may simplify the user interface. Such touchscreen-equipped mobile terminals provide an intuitive user interface, especially when surfing the Internet. The touchscreen-equipped mobile terminal detects the occurrence of a touch event, for example, a touch by a stylus or a user's finger, on the touchscreen and executes an operation associated with the touch event.

However, the pinpoint accuracy of a conventional touchscreen-equipped mobile terminal may not be satisfactory when the touch event is a finger touch. This is even more so when a user attempts to select one of a plurality of hyperlinks of a webpage displayed on a touchscreen having a limited size. That is, the finger touch on the touch screen is likely to select other adjacent hyperlinks as well as the target hyperlink. Furthermore, the limited size of the touchscreen may cause a finger to cover other hyperlinks when a user tries to select a target hyperlink, whereby the user may not be able to intuitively check whether the target hyperlink is selected.

### SUMMARY OF THE INVENTION

The present invention provides a hyperlink selection method using a touchscreen that may be capable of selecting a target hyperlink accurately and a mobile terminal having the hyperlink selection method.

Additional features of the invention will be set forth in the description which follows, and in part will be apparent from the description, or may be learned by practice of the invention.

The present invention discloses a hyperlink selection method including detecting the occurrence of a touch event in which a touch point on a touchscreen displaying a webpage including a plurality of hyperlinks is touched, determining a number of the hyperlinks involved in the touch event, displaying icons corresponding to the hyperlinks if the number of hyperlinks involved in the touch event is greater than or equal to two, and selecting an icon in response to movement of the touch point to one of the displayed icons.

The present invention also discloses a mobile terminal having a touchscreen including an area scaling module to define a touch area surrounding a touch point input through the touchscreen and a link processing module to cause display of icons representing the hyperlinks when at least two hyperlinks are at least partially included within the touch area and to select one of the icons in response to a movement of the touch point.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing a configuration of a mobile terminal according to an exemplary embodiment of the present invention.

FIG. 2 is a diagram showing the exemplary access information database of FIG. 1.

FIG. 3 is a flowchart showing a hyperlink selection method according to an exemplary embodiment of the present invention.

FIG. 4A, FIG. 4B, FIG. 4C, FIG. 4D, FIG. 4E, FIG. 4F, and FIG. 4G are screen images showing steps of the hyperlink selection method of FIG. 3.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

In the following, the touchscreen is implemented in the form of a display screen having an input means (e.g., touch panel). A physical touch event detected on the display screen is converted into an electrical signal, which is transmitted to a controller.

In the following, a webpage is a hypertext document that is a part of a website accessible on the Internet.

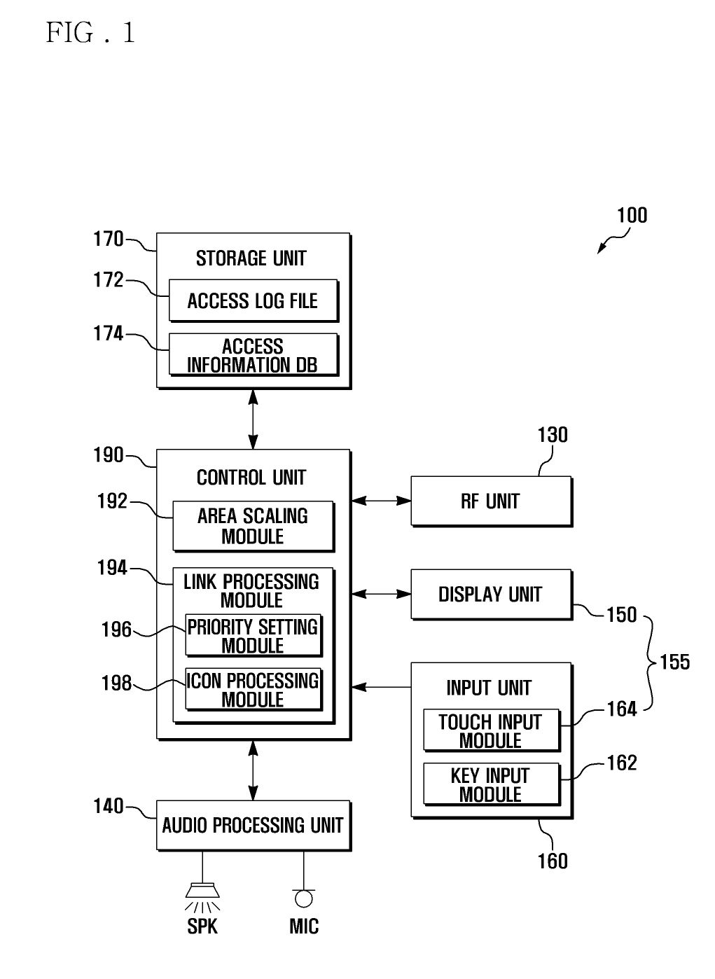

FIG. 1 is a block diagram showing a configuration of a mobile terminal according to an exemplary embodiment of the present invention.

Referring to FIG. 1, the mobile terminal 100 includes a radio frequency (RF) unit 130, an audio processing unit 140, an input unit 160, a display unit 150, a storage unit 170, and a control unit 190.

The RF unit 130 is responsible for radio communication of the mobile terminal 100. The RF unit 130 includes an RF transmitter to up-convert and amplify a transmission signal and an RF receiver to low-noise amplify and down convert a received signal. The RF unit 130 outputs the data received through a radio channel to the control unit 190 and transmits the data output by the control unit 190 through a radio channel.

The audio processing unit 140 includes a codec (coder/decoder). The codec is provided with a data codec to process packet data and an audio codec to process audio data including voice. The audio processing unit 140 converts a digital audio data output by the control unit 190 to an analog audio signal through the audio codec and outputs the analog audio signal through a speaker (SPK) in the form of an audible sound wave. The audio processing unit 140 also converts an analog audio signal input through a microphone (MIC) to digital audio data and outputs the digital audio data to the control unit 190.

The display unit 150 displays various menu screens associated with application programs, user data input by the user, function configuration information, and application data. The display unit 150 may be implemented with a Liquid Crystal Display (LCD). In this case, the display unit 150 may include a controller, a video memory to store video data, and pixel devices.

In more detail, the display unit 150 is provided with an LCD panel (not shown) and a backlight unit (not shown). The LCD panel includes a pair of glass substrates with liquid crystal filled in the narrow gap between the two substrates. The backlight unit is located on the backside of the LCD panel. Each liquid crystal cell acts as an electro-optical switch that controls the light transmission from the backlight unit according to a signal applied to a signal electrode such that a color can be determined according to the transmissivity. When the LCD panel of the display unit 150 includes a touchscreen, the display unit 150 may act as a part of the input unit 160.

The input unit 160 receives a user manipulation signal and outputs a sequence corresponding to the signal to the control unit 190. The input unit 160 is provided with a key input module 162 through which a user may input a key sequence and a touch input module 164 disposed on the display unit 150.

The key input module 162 is provided with a plurality of control keys (not shown) for executing operations of the mobile terminal 100 and a plurality of alphanumeric keys (now shown) for inputting alphanumeric data.

The touch input module 164 converts a voltage or a current signal generated by a touch on the touch panel to a corresponding input signal and transmits the input signal to control unit 190.

When a touch panel is used as the touch input module 164, the touch input module 164 may include a pair of substrates having conductive patterns made of Indium Tin Oxide (ITO) or polyethyleneterephthalate (PET) film, electrode patterns, and spacers to secure space between the substrates. In this case, the conductive patterns include a conductive X axis pattern and a conductive Y axis pattern, and the X and Y axis patterns are separated by dielectric material. If a user touches a location on the upper substrate with a finger, the conductive ITO pattern of the upper substrate contacts the conductive ITO pattern of the lower substrate such that a coordinate on the position touched by the finger is achieved from the voltages on the X axis pattern and the Y axis pattern and transmitted to the control unit 190.

The storage unit 170 stores application programs associated with the hyperlink selection method according to an exemplary embodiment of the present invention and user data downloaded from websites and input by the user. The storage unit 170 may include a program region and a data region.

The program region stores an operating system (OS) to manage terminal resources and provide the user with an interface to access resources and application programs to execute optional functions of the mobile terminal, such as audio and video playback functions. If a specific function is requested by the user, an application program associated with the requested function is executed under the control of the control unit 190. The storage unit 170 may be provided with at least one buffer to buffer application data generated while the application program plays a multimedia file, such as an audio and video file.

The data region stores the various user data such as content files including audio files and still and motion pictures.

Particularly in this exemplary embodiment, the data region stores an access log file 172 to record information of the user access to a webpage and an access information database (DB) 174 to store access information extracted from the access log file 172.

The access log file 172 automatically records information regarding the access of the mobile terminal to the webpage.

The access information DB 174 extracts access information, such as the domain address of the webpage and the time the webpage was accessed, and stores the access information.

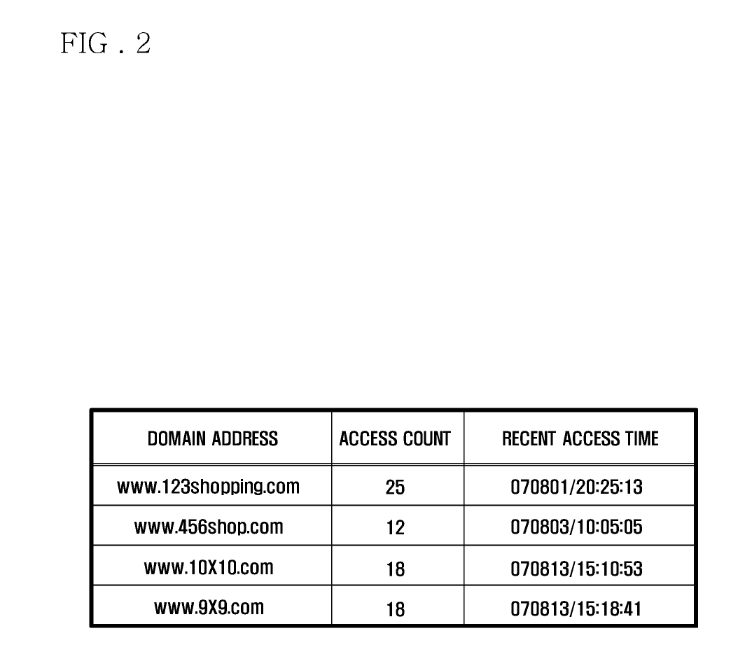

FIG. 2 is a diagram showing the exemplary access information DB of FIG. 1. As shown in FIG. 2, the access information DB 174 is composed of a domain address field, an access count field, and a most recent accessed time field.

The domain address field is filled with the domain addresses of the webpages accessed by the user. When the user access a webpage, the information of the access to the webpage is recorded to the access log file 172. The access information DB 174 extracts the domain address from a URL of the webpage recorded in the access log file 172 and stores the domain address within its domain address field. For example, when the mobile terminal 100 accesses a web page having the URL “http://www.123shpping.com/category?s=&z=&fid=&mid=&p=&cat=10”, the control unit 190 of the mobile terminal 100 records the URL and the access time in the access log file 172. Accordingly, the access information DB 174 extracts the domain address “www.123shopping.com” from the URL and stores the domain address in its domain address field.

Here, the access information DB 174 refers to the previously stored domain address and stores a newly recognized domain address.

The access count field stores a number of times the mobile terminal accesses the same domain address. Whenever the mobile terminal 100 accesses the webpage corresponding to the domain address, the value of the access count field increases by 1.

The most recent access time field stores the most recent time a webpage corresponding to a domain address has been accessed using the mobile terminal 100.

In FIG. 2, it is shown that the user accessed the domain of URL “www.123shopping.com” most frequently (25 times) and the domain of URL “www.456shop.com” least frequently (12 times) using the mobile terminal 100. The mobile terminal 100 also includes the access records of the domains “www.10X10.com” and “www.9X9.com”, which have been accessed the same number of times, and indicates that the domain “www.9X9.com has been accessed the most recently.

Whenever the access log file 172 is updated, the access information DB 174 automatically extracts a new access domain address and stores the domain address in real time. Updating of the access information DB 174 may be performed periodically (e.g., every day or every week).

Although the access information DB 174 extracts the information from the access log file 172 in this exemplary embodiment, the present invention is not limited thereto. For example, the access information of the mobile terminal 100 may be gathered and stored in the access information DB 174 by an information extractor (not shown).

The control unit 190 controls the general operation of the mobile terminal 100 and signaling between internal components. That is, the control unit 190 controls cooperative signaling among the RF unit 130, the audio processing unit 140, the display unit 150, the input unit 160, and the storage unit 170.

Particularly in this exemplary embodiment, the control unit 190 recognizes the selection of multiple hyperlinks by a touch event and displays icons representing the multiple hyperlinks. In order to process the multiple hyperlink selection, the control unit 190 includes an area scaling module 192 and a link processing module 194.

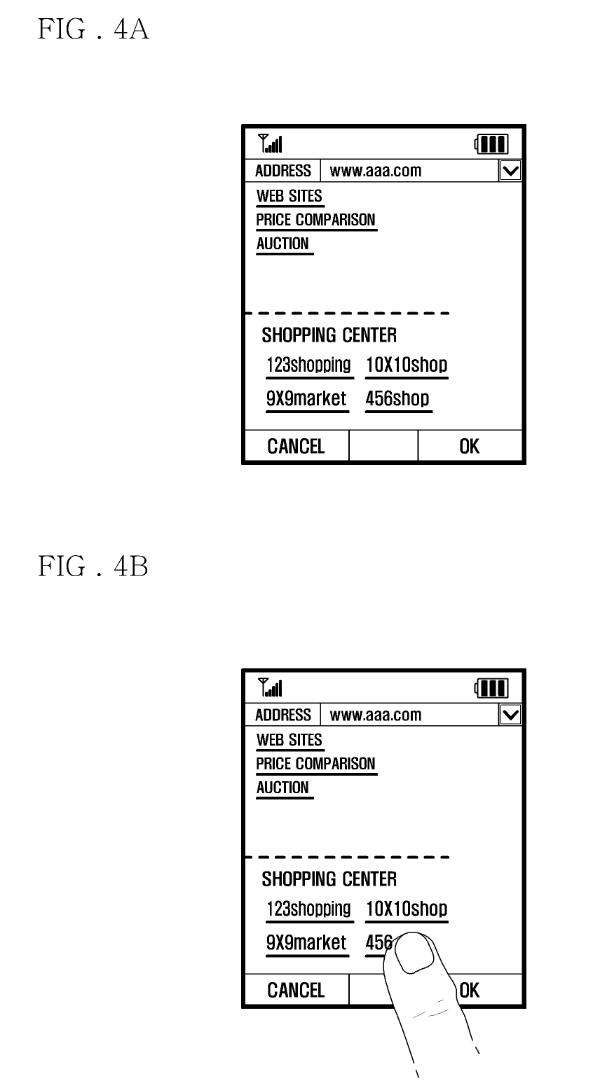

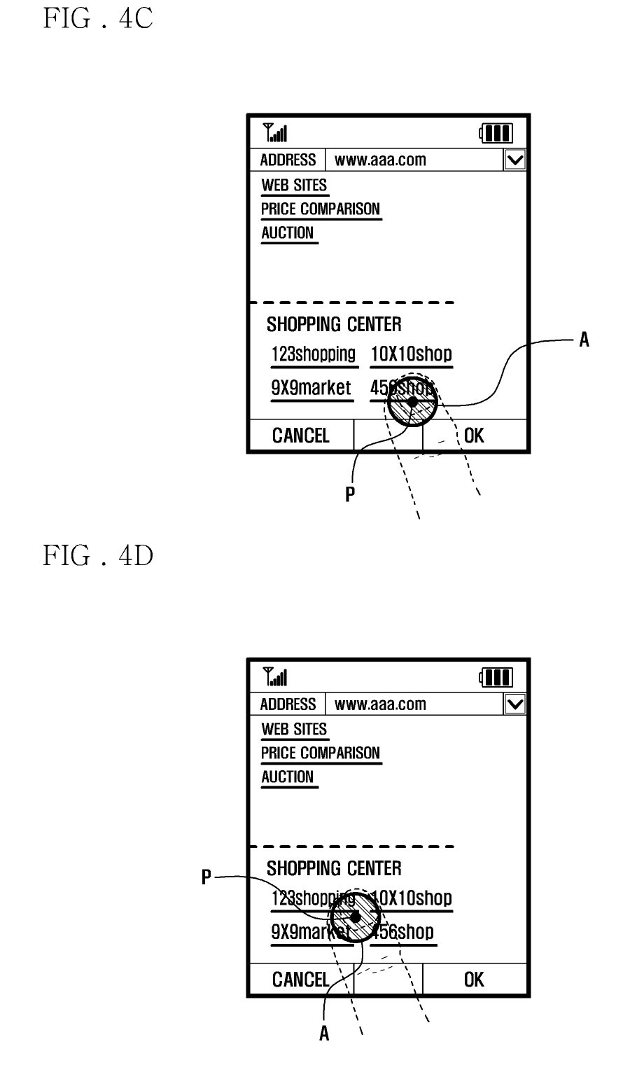

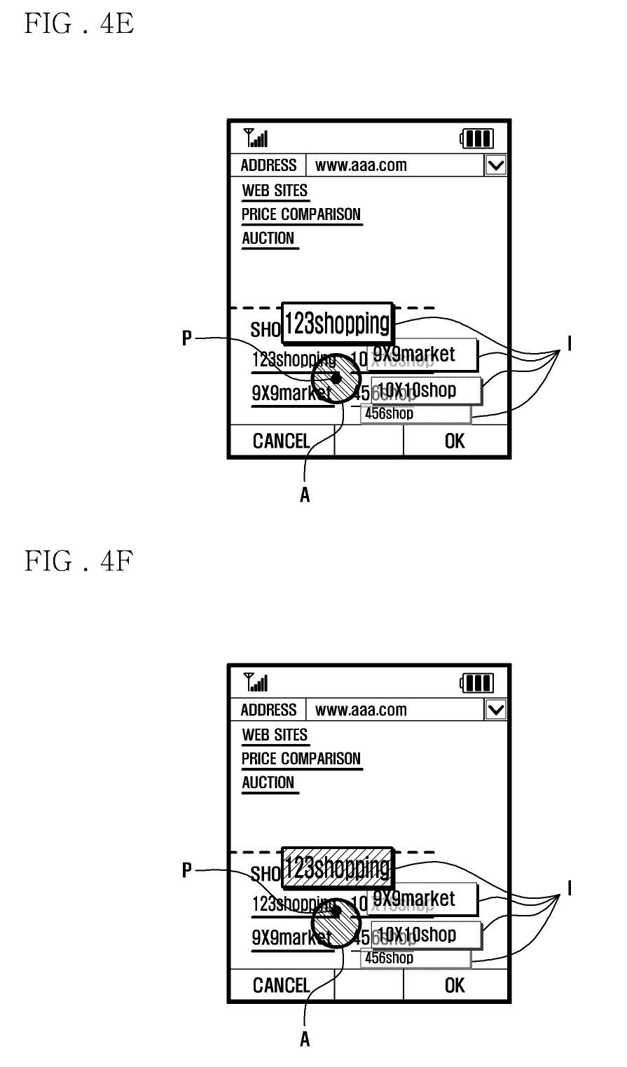

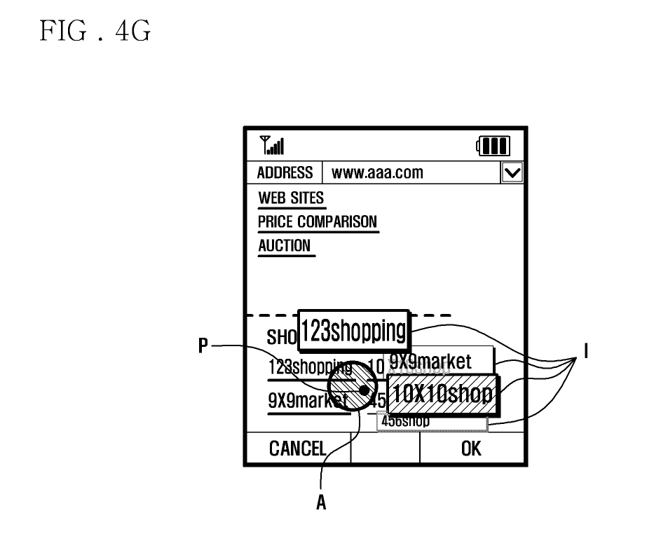

The area scaling module 192 defines a touch area on the touch input module 164 on the basis of the touch point. Here, the touch point (P in FIG. 4D) is a location on the touch input module 164 that is touched by a finger, and the touch area (A in FIG. 4D) is an area surrounding the actual touch point P. In this exemplary embodiment, the touch area A is a circular area having a radius of 1.5 cm. However, the touch area A is not limited to a circular shape. For example, the shape of the touch area A may be rectangular or hexagonal in various sizes.

The link processing module 194 checks a number of the hyperlinks in the touch area A and displays the hyperlinks in the forms of icons if two or more hyperlinks exist in the touch area A. If the touch point P moves across the icons, the link processing module 194 highlights the icon on which the touch point P is located. For this purpose, the link processing module 194 includes a priority setting module 196 and an icon processing module 198.

The priority setting module 196 extracts the domain addresses of the hyperlinks detected in the touch area A and assigns priorities of the hyperlinks on the basis of the access information to the domain addresses. Here, the access information is provided by the access information DB 174. The access information may include the domain addresses of the webpage indicated by the hyperlinks, the number of times the webpages have been accessed, and the most recent access times. In this exemplary embodiment, the priority setting module 196 determines the priorities of the hyperlinks on the basis of the number of times the respective webpages have been accessed. The greater the number is, the higher the priority is. When at least two hyperlinks have been accessed the same number of times, the priority setting module assigns a higher priority to the most recently accessed hyperlink.

The icon processing unit 198 presents the icons corresponding to the hyperlinks in an order of priority determined by the priority setting module 196. The icon processing unit 198 may present the icons distinctively according to the priorities of the hyperlinks.

In this exemplary embodiment, the icons are presented in distinctive size and transparency according to the priorities of the hyperlinks. However, the present invention is not limited thereto. For example, the icons can be expressed in different colors and/or with animations.

The control unit 190 controls the functions of the mobile terminal 100 in response to the control signal input through the input unit 160 and displays the operation status of the mobile terminal 100 and indicative information through the display unit 150. The touch input mechanism of the above structured mobile terminal is described hereinafter in more detail.

If a touch event is detected, the touch input module 164 computes the coordinates of the touch point P and transmits the touch information to the control unit 190. That is, the touch input module 164 converts the touch event including the touch point P and trace of the movement of the touch point P to an electric voltage or current signal and transmits the electric signal as a touch signal to the control unit 190. If the touch signal is received, the control unit 190 executes an operation corresponding to the touch signal. The touch input module 164 may generate different touch signals according to the location and the length of the touch. The touch events may be tap events or drag events. A tap event may be a short tap event or a long tap event that can be interpreted as a short key or a long key event of the key input module 162, respectively.

In order to simplify the explanation, the touch input unit 164 and the display unit 150 are regarded as an integrated touchscreen 155 in the following description.

A hyperlink selection method of the above structured mobile terminal is described hereinafter.

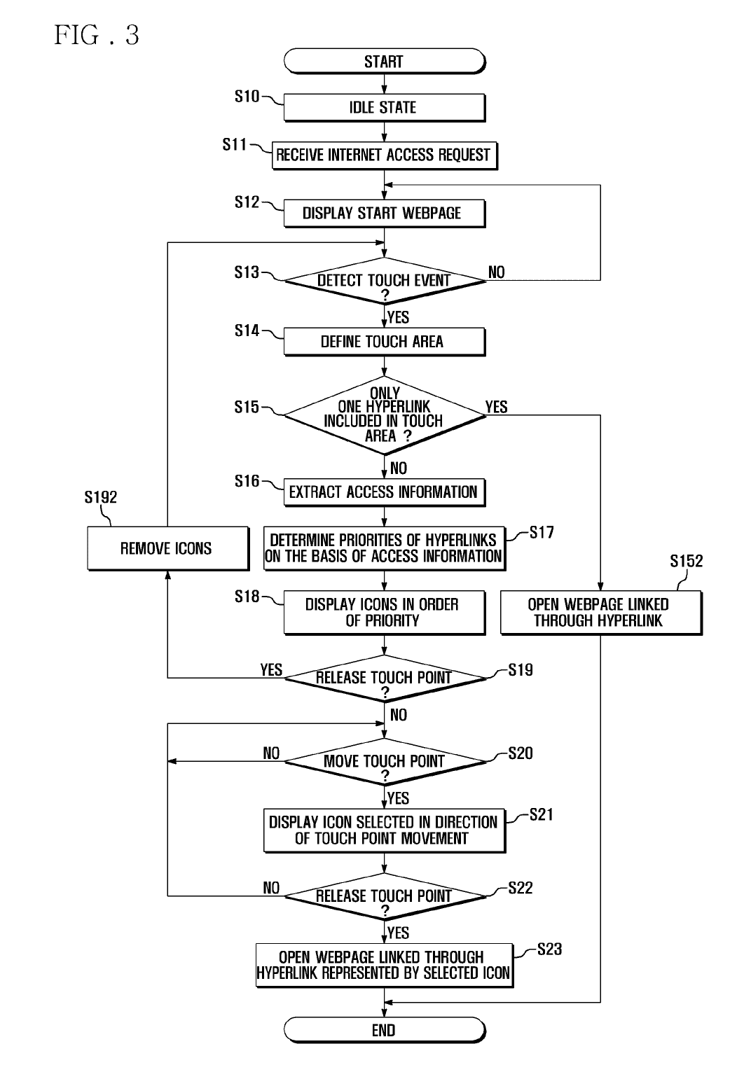

FIG. 3 is a flowchart showing a hyperlink selection method according to an exemplary embodiment of the present invention, and FIG. 4A, FIG. 4B, FIG. 4C, FIG. 4D, FIG. 4E, FIG. 4F, and FIG. 4G are screen images showing steps of the hyperlink selection method of FIG. 3.

Referring to FIG. 3, if the mobile terminal 100 is turned on, the mobile terminal enters an idle mode (S10) and then detects an Internet access request signal (S20). Typically, the Internet access request signal is generated in response to a specific key input by the user.

If an Internet access request signal is detected, the control unit 190 of the mobile terminal 100 establishes a connection to the Internet and displays a start webpage of a website registered by the user (S12).

FIG. 4A shows an exemplary start webpage. In order to move to another webpage the user selects one of the hyperlinks embedded within the start webpage. The hyperlink selection is performed by a user touching a hyperlink on the touchscreen 155 (see FIG. 4B) such that the touch input module 164 detects the touch event and transmits a touch signal corresponding to the touch event to the control unit 190.

The control unit 190 determines whether a touch event occurs on the basis of the touch signal (S13) and, if it is determined that a touch event has not occurred, the start webpage continues to be displayed (S12). However, if it is determined that a touch event occurs, the control unit 190 defines a touch area (S14). As shown in FIG. 4C, the touch area “A” is a circular area surrounding the touch point “P”.

Next, the control unit 190 determines whether one or more hyperlinks are at least partially included in the touch area A and determines if only one hyperlink is included in the touch area A (S15). If only one hyperlink exists within the touch area A (456shop in FIG. 4C), the control unit 190 opens a webpage linked through the hyperlink with reference to the URL (S152). If multiple hyperlinks (i.e. two or more) are included within the touch area A, the control unit 190 performs an operation to present the hyperlinks in the form of corresponding icons. At this time, the link processing unit 194 judges that any hyperlink that is partially included within the touch area A is selected. However, the preset invention is not limited thereto, for example, the link processing module may be configured to regard a hyperlink that is at least 20% in the touch area A as selected.

The priority setting module 196 of the link processing module 194 extracts the domain addresses of the hyperlinks within the touch area A. For example, if the hyperlink titled “123shopping” has a URL of “http://www.123 shopping.com/category?s=&z=&fid=&mid=&p=&cat=10”, the priority setting module 196 extracts the domain address “www.123shopping.com” from the URL.

Next, the priority configuration unit 196 extracts access information of the hyperlinks within the touch area (S16). The access information includes the number of times each corresponding domain address has been accessed and the most recent access time information for each corresponding domain address. In the example of FIG. 2, the domain “www.123shopping.com” has been accessed 25 times and the most recent access time is 070801/20:25:13.

In FIG. 2, the domains “www.10X10.com” and “www.9X9.com” have been accessed the same number of times. In this exemplary embodiment, if there are at least two hyperlinks corresponding to respective domains that have been accessed the same number of times, the hyperlink of the domain that has been most recently accessed is assigned the higher priority. Accordingly, the hyperlink “www.9X9.com” has higher priority than the hyperlink “www.10X10.com”.

If the four hyperlinks of FIG. 2 are included in the touch area A as shown in FIG. 4D, the priorities of the hyperlinks are in an order of www.123shopping.com, www.9X9.com, www.10X10.com, and www.456shop.com.

In order to simplify the explanation, the hyperlink selection procedure is described with the case of FIG. 4D in which the four hyperlinks listed in FIG. 2 are included within the touch area A.

After assigning priorities to the hyperlinks included within the touch area A, the icon processing module 198 presets the icons corresponding to the hyperlinks on the touch screen 155 in an order of priority (S18). In this exemplary embodiment, the hyperlinks are presented in the forms of distinctive icons. That is, the icon processing module 198 creates icons I corresponding to the respective hyperlinks and presents the icons I on the touchscreen 155 in a discrete manner as shown in FIG. 4E. These icons I are displayed distinctively according to the priorities assigned at step S17. That is, the icon processing module 198 presents the icon of the hyperlink having the highest priority with more recognizable features.

In this exemplary embodiment, the icons I are presented in the shape of a rectangular box having texts indicating the domain. The icon processing module 198 may present the icons distinctively in box size, text size, and transparency level. In FIG. 4E, the icon processing module 198 expresses the priority of the hyperlinks using the sizes of the icons. Also, the higher the priority of the hyperlink, the lower the transparency level of the icon.

In this exemplary embodiment, the icons I of the hyperlinks are arranged around the touch area A. That is, the icons are arranged in a clockwise direction from 12 o'clock in a descending priority order. If the number of icons I is too large, the icons I may overlap.

In this exemplary embodiment, each icon I includes text indicating the domain name of the webpage. If the domain name is too long, an indicative part of the domain name may be used as the text of the icon I.

If the touch area A is located at a side of the touchscreen 155, the icons may be arranged so as not to disappear from the screen.

The icon processing module 198 may process the webpage to be blurred or darkened to improve the legibility of the icons.

After the icons I are presented, the link processing unit 194 monitors the movement of the touch point P and determines whether the touch point P is released (S19). If the touch point P is not released (i.e., the user keeps their finger on the touchscreen 155), the link processing module 194 stops displaying the icons I on the touch screen 155 (S192), whereby the touchscreen displays the webpage (S12) as shown in FIG. 4A.

In contrast, if the touch point P moves on the touch screen, the link processing module 194 detects the movement of the touch point P (S20) and selects an icon located in the movement direction (S21). For example, if the user drags his/her finger such that the touch point P moves in a 12 o'clock direction, the link processing module 194 selects the icon titled “123shopping” and modifies the color, shape, or size of the icon to indicate its selection. For example, as shown in FIG. 4F, “123shopping” may be highlighted.

Sequentially, the link processing module 194 checks whether the touch point P is released (S22). If the touch point P is not released, the link processing module 194 repeats steps S20 and S21. For example, if the touch point P moves in a 3 o'clock direction, the link processing unit 194 selects the icon titled “10X10shop” and modifies the color and/or size of the icon. For example, as shown in FIG. 4G, when the touch point P moves, “123shopping” is no longer highlighted, but “10X10shop” becomes highlighted.

If it is determined that the touch point P is released from the touchscreen at step S22, the link processing module 194 displays a webpage linked by the icon on which the touch point P is released (S23). That is, if the touch point P is released while the icon titled “123shopping” is selected, the link processing module 194 displays the webpage of the URL (e.g., http://www.123shopping.com/category?s=&z=&fid=&mid=&p=&cat=10).

As described above, the hyperlink selection method and mobile terminal using the hyperlink selection method checks hyperlinks included within a touch area, assigns priorities to the hyperlinks if multiple hyperlinks are included within the touch area, and presents icons representing the respective hyperlinks in a distinctive manner, whereby a user may accurately select a hyperlink.

Also, the hyperlink selection method and mobile terminal using the hyperlink selection method presents multiple hyperlinks influenced by a finger touch in the forms of distinctive icons, which may improve selection accuracy. Accordingly, even when the hyperlinks are covered by the finger, the mis-selection possibility may be minimized.

Although the above exemplary embodiments show the hyperlink selection method with icons having a shape of rectangular box, the present invention is not limited thereto. For example, the icons can be implemented in various shapes with any image or animation.

Also, the icons are arranged in the clockwise direction around the touch point in the above exemplary embodiments. However, the hyperlink selection method of the present invention can be implemented such that the icons are displayed anywhere on the touchscreen in various arrangements.

Although the hyperlink selection method is described with the hyperlinks embedded in text, the hyperlinks may be embedded in other types of objects such as images. In this case, the icons may be replaced by enlarged versions of the images. Although described with the mobile terminal in the above exemplary embodiments, the hyperlink selection method of the present invention may be applied to any of various electric devices that support touchscreen functionality.

As described above, the hyperlink selection method and mobile terminal using the hyperlink selection method may minimize the possibility of mis-selecting a hyperlink on a touchscreen having a limited size. Also, the hyperlink selection method displays the hyperlinks in the form of distinctive icons, thereby facilitating selection of a target hyperlink. Furthermore, since the hyperlinks are presented distinctively in an order of priority, the user may quickly recognize a target hyperlink with reference to the informative icons.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A hyperlink selection method, comprising:
detecting an occurrence of a touch event in which a touch point on a touchscreen displaying a webpage including a plurality of hyperlinks is touched;
determining a number of hyperlinks involved in the touch event;
displaying icons corresponding to the hyperlinks if the number of hyperlinks involved in the touch event is greater than or equal to two; and
selecting an icon in response to movement of the touch point to one of the displayed icons.

2. The hyperlink selection method of claim 1, wherein determining a number of hyperlinks comprises:
defining a touch area surrounding the touch point; and
counting the number of the hyperlinks that are at least partially within the touch area.

3. The hyperlink selection method of claim 2, wherein displaying icons comprises:
extracting information of the hyperlinks that are at least partially within the touch area;
determining priorities of the hyperlinks on the basis of the information; and
presenting the icons in an order of priority.

4. The hyperlink selection method of claim 3, wherein the information comprises domain addresses of the hyperlinks and numbers of times the respective domain addresses have been accessed.

5. The hyperlink selection method of claim 4, wherein determining priorities of the hyperlinks comprises:
extracting domain addresses from uniform resource locators (URLs) of the hyperlinks;
checking the number of times each domain address has been accessed with reference to a previously stored access log file; and
assigning priorities to the hyperlinks based on the number of times the corresponding domain addresses have been accessed, a higher number corresponding to a higher priority.

6. The hyperlink selection method of claim 5, wherein determining priorities of the hyperlinks further comprises assigning a higher priority to a hyperlink that has been most recently accessed out of two or more hyperlinks that have been accessed the same number of times.

7. The hyperlink selection method of claim 3, wherein the icons have different sizes from each other.

8. The hyperlink selection method of claim 3, wherein the icons have different transparency levels from each other.

9. The hyperlink selection method of claim 1, wherein the icon is selected in response to a dragging movement of the touch point.

10. The hyperlink selection method of claim 9, further comprising displaying a webpage linked through the hyperlink represented by the selected icon in response to release of the touch point.

11. The hyperlink selection method of claim 1, further comprising displaying a webpage linked through the hyperlink involved in the touch event when there is only one hyperlink involved in the touch event.

12. A mobile terminal having a touchscreen, comprising:
an area scaling module to define a touch area surrounding a touch point input through the touchscreen; and
a link processing module to cause display of icons representing the hyperlinks when at least two hyperlinks are at least partially within the touch area, and to select one of the icons in response to a movement of the touch point.

13. The mobile terminal of claim 12, wherein the link processing module comprises:
a priority setting module to extract information of the hyperlinks included within the touch area and to determine priorities of the hyperlinks on the basis of the information; and
an icon processing module to display the icons representing the hyperlinks in order of priority.

14. The mobile terminal of claim 12, wherein the information comprises domain addresses of the hyperlinks and numbers of times the respective domain addresses have been accessed.

15. The mobile terminal of claim 14, wherein the priority setting module extracts domain addresses from uniform resource locator (URL) addresses of the hyperlinks, checks the numbers of times the respective domain addresses have been accessed with reference to a previously stored access log file, and assigns the priorities of the hyperlinks on the basis of the numbers, a higher number corresponding to a higher priority.

16. The mobile terminal of claim 15, wherein the priority setting module assigns a higher priority to a hyperlink that was most recently accessed out of two or more hyperlinks that have been accessed the same number of times.

17. The mobile terminal of claim 13, wherein the icon processing module presents the icons with different sizes from each other.

18. The mobile terminal of claim 13, wherein the icon processing module presents the icons with different transparency levels from each other.

19. The mobile terminal of claim 12, wherein the link processing module selects an icon when the touch point moves and highlights the selected icon.
